(19) United States
(12) Patent Application Publication
(10) Pub. No.: US 2022/0260457 A1
(43) Pub. Date: Aug. 18, 2022

(54) MOVABLE PLATFORM FOR A DUMMY ELEMENT

(71) Applicant: 4ACTIVESYSTEMS GMBH, Traboch (AT)

(72) Inventors: Reinhard Hafellner, Spielberg (AT); Martin Fritz, Kobenz (AT)

(73) Assignee: 4ACTIVESYSTEMS GMBH, Traboch (AT)

(21) Appl. No.: 17/620,621

(22) PCT Filed: Jun. 16, 2020
(86) PCT No.: PCT/EP2020/066602

§ 371 Date: Dec. 17, 2021

(30) Foreign Application Priority Data
Jun. 19, 2019 (DE) 10 2019 116 688.8

(51) Int. Cl. G01M 17/007; G01M 7/08

(52) U.S. Cl. CPC G01M 17/0078; G01M 7/08

(57) ABSTRACT

The present invention relates to a platform for testing of collisions or near-collision situations between a dummy element and an object to be tested, in particular a vehicle. The platform comprises a base body having a bottom surface and a mounting surface formed opposite to the bottom surface, wherein the dummy element is attachable to the mounting surface. The platform further comprises a roller element arranged at the bottom surface, wherein the roller element is drivable such that the base body is movable along a ground. Further, the platform comprises an alignment device which aligns the base body on the ground in a predetermined orientation.

This application is the U.S. national phase of International Application No. PCT/EP2020/066602 filed 16 Jun. 2020 which designated the U.S. and claims priority to German Patent Application No. 10 2019 116 688.8 filed 19 Jun. 2019, the entire contents of each of which are hereby incorporated herein by reference.

### TECHNICAL FIELD

Embodiments of the present invention relate to platforms for a dummy element for testing of collisions or near-collision situations between a dummy element and an object to be tested, in particular a vehicle.

### BACKGROUND

In modern vehicle technology, more and more assistance systems are being used that actively monitor the vehicle's surroundings and passively or actively intervene in the control of the vehicle. In particular, assistance systems for the implementation of autonomous driving must be extensively tested. Assistance systems must therefore be subjected to comprehensive tests in order to prevent misjudgments by the assistance systems.

During a test run of assistance systems, collisions between the object to be tested and the dummy element may in fact be caused. In order to create a realistic collision situation, such as a collision between two vehicles or a vehicle and a person in traffic, the vehicle to be tested and the dummy element are set in motion. Thereby, in particular driver assistance systems can be tested in a manner close to reality.

In order to test an assistance system for all conceivable situations, it is necessary that the vehicle as well as the dummy element move towards each other from test to test from different directions. In order to test such situations effectively, it is necessary that a test system can be adapted to different test situations quickly and without complex modifications. In particular, complex traffic situations have to be simulated, where a plurality of different dummy elements, such as dummy vehicles, human dummies, move in different directions towards each other. Due to the use of a plurality of dummy elements, a cost-effective and, in particular after collisions, reusable dummy device is necessary.

### DESCRIPTION OF THE INVENTION

There may be a need to provide a robust and cost-effective platform for dummy elements for testing assistance systems.

This need may be met by the features of the independent claim.

According to a first aspect of the present invention, a platform is provided for testing of collisions or near-collision situations between a dummy element and an object to be tested, in particular a vehicle. The platform comprises a base body having a bottom surface and a mounting surface (fastening surface, fixing surface, attachment surface) formed opposite to the bottom surface, wherein the dummy element is (e.g. detachably) attachable to the mounting surface. The platform further comprises a roller element arranged at the bottom surface, wherein the roller element is drivable (may be driven) such that the base body is movable along a ground (floor, bottom). Further, the platform comprises an alignment device which aligns the base body on the ground in a predetermined orientation.

According to a further aspect, a method of operating the platform described above is provided.

According to another aspect of the present invention, a test system is provided for testing of collisions or near-collision situations between an object to be tested, in particular a vehicle, and a dummy element. The test system comprises a platform of the type described above and a dummy element, wherein the dummy element is particularly releasably mounted (attached, fixed) on the mounting surface by means of a mounting device (fixing device).

For example, the object to be tested may represent a stationary object, such as a vehicle. Alternatively, the object to be tested may be moving and may represent, for example, a vehicle, such as a passenger car, truck, bus, or bicycle.

The dummy element mounted on the platform is, for example, a human-like dummy mounted on the platform in a standing, lying or sitting position. Further, the dummy element may be a vehicle dummy or a bicycle dummy.

The platform is drivable (may be driven) by the roller element and is movable (may be moved) along a ground. The platform on which the dummy element is arranged may cross the travel path of the object to be tested, so that the approach of the dummy element to the object to be tested may be measured by means of driver assistance systems and these may be tested at the same time.

The platform has the base body, which forms a plate-like shape. This means that its extension within a ground plane is significantly greater than its thickness in, for example, the vertical direction. The base body has a bottom surface and an opposite mounting surface. The base body is placed with its bottom surface on a ground. The at least one roller element, which at least partially protrudes from the base body and thus provides a distance between the base body and the ground, is drivably arranged in the bottom surface. The dummy element is mounted on the mounting surface, for example by means of a mounting device.

The at least one roller element is arranged at the bottom surface. The roller element may, for example, comprise rubber rollers, hard plastic rollers or plastic rollers. In particular, the roller element is arranged in the front region in the direction of movement of the platform, i.e. in the front half with respect to a predefined direction of movement of the platform.

The platform is movable along the ground along a direction of movement by means of the at least one roller element. In particular, the platform has a direction of extension which is defined parallel to a desired and predefined direction of movement of the platform. The platform is designed to be freely movable in that the roller element itself is driven and, according to an exemplary embodiment, is designed to be steerable or rigid and non-steerable.

Further, the platform comprises the alignment device which aligns the base body on the ground in a predetermined orientation. In particular, the predetermined alignment may be the alignment in which the direction of extension of the platform is parallel to a desired direction of movement of the platform. In particular, the alignment device is arranged at a distance (spaced apart) from the roller element. In particular, the alignment device is arranged behind the roller element in the direction of extension or movement of the platform.

The alignment device is configured to align the platform in a predetermined orientation, for example, via a resistance to movement with the ground or an active orientation system by means of a mass body, as described further below. The alignment device has, for example, a higher resistance to movement or a higher frictional force with the ground than the roller element has with the ground. This results in an aligning moment being generated when the platform moves, in particular accelerates, in the direction of movement due to the distance between the alignment device and the driving roller element, which moment forces the alignment device exactly behind the roller element with respect to the direction of movement and thus aligns the platform in the predetermined orientation. Alternatively, in addition to a friction-based alignment, the alignment device may also enable an alignment of the platform by means of a movable mass element as further described.

Thus, a platform is provided that does not require complex steering mechanisms or a plurality of necessary dynamic control elements.

According to another exemplary embodiment, the platform comprises exactly one single roller element. Due to the pairing of a single roller element with the alignment device, which automatically stabilizes the base body, for example during movement along the direction of movement, it is not necessary to provide two or more roller elements. Exclusively one roller element, which in particular is drivable to move the platform, is sufficient. Thus, a simple and inexpensive platform may be provided.

Since the platform has exactly one single roller element, the alignment device is just not a roller element or is not designed as a rotatable roller element.

According to another exemplary embodiment, the roller element is controllable or steerable relative to the base body about a steering axis to adjust a direction of movement of the base body. In that the drivable roller element may be pivoted about a vertical longitudinal axis, steering of the platform may be implemented.

According to another exemplary embodiment, the roller element is rotationally fixed, i.e. non-steerable, relative to the base body about a longitudinal axis. For example, during certain test runs, the platform may be moved exclusively along a linear path or along a predetermined curved path. In this case, an active steering of the roller element is not necessary. Further, the alignment of the platform may be actively aligned using an active alignment device, such as via the mass element described below, so that no steerable roller element is necessary.

According to another exemplary embodiment, the roller element is configured to drive the base body along a direction of extension of the base body, wherein the alignment device is arranged along the direction of extension behind the roller element.

According to another exemplary embodiment, the alignment device comprises a ground contact element (bottom contact element, floor contact element) configured for contacting, in particular by means of a sliding contact, with the ground (bottom, floor) during the movement (travel) of the base body along the bottom. The ground contact element thus forms a frictional contact with the ground. The ground contact element thus exhibits a higher resistance to movement or a higher frictional force with the ground than the roller element with the ground. As a result, during movement, in particular during acceleration, of the platform in the direction of movement, an aligning moment is generated due to the distance of the alignment device to the driving roller element, which forces the alignment device exactly behind the roller element with respect to the direction of movement and thus aligns the platform in the predetermined orientation.

The ground contact element may form a hemispherical body as described below or may form another geometric shape such as a cuboid, cone, cylinder, prism or pyramid.

According to another exemplary embodiment, the ground contact element comprises a hemispherical body. With a hemispherical shape, a small contact surface with the ground is generated. At the same time, in case of wear of the hemispherical body or in case of unevenness of the ground, a sufficient friction surface is ensured. The hemispherical body may in particular be made of a rubber-like material, in particular hard rubber.

According to a further exemplary embodiment, the ground contact element forms at least one lamella which has a direction of extension having a component parallel to the direction of extension of the base body. In other words, the lamella forms with the ground a friction surface which has a longer extension in the direction of extension or movement of the base body than in a direction transverse or orthogonal to the direction of extension. As a result, a frictional force orthogonal to the direction of movement is greater than a frictional force parallel to the direction of movement. Accordingly, when the platform moves along the ground, on the one hand a resistance orthogonal to the direction of movement is increased and, on the other hand, a moment is generated which brings the lamella and thus the platform as possible into an orientation with the lowest frictional force transverse to the direction of movement. This orientation typically corresponds to the given orientation of the platform.

According to another exemplary embodiment, the angle between the direction of extension of the lamella and the direction of extension/direction of movement of the base body is less than 45°.

According to a further exemplary embodiment, the ground contact element comprises a plurality of elastic pin elements (pin members) extending between the bottom surface and the ground along a direction of extension of the ground (bottom, floor), wherein the direction of extension of the ground has a directional component extending along a bottom plane perpendicular to the direction of extension of the base body. In particular, the elastic pin elements have a high resistance along their longitudinal direction and may be elastically deformed transversely to their longitudinal direction. The elastic pin elements are brush-like and form, for example, a thin hair-like mat/pelt, each of the pin elements being selectively aligned as described above. In other words, the pin elements extend outwardly from the bottom surface of the platform in a direction towards the ground, i.e. opposite to a central axis of the platform. Thus, when the platform moves in a rotational motion about the roller element and thus from this central position, the pin elements generate a higher resistance.

According to a further exemplary embodiment, the pin elements are arranged in such a way that the direction of extension of the ground has a directional component which is opposite (runs counter) to the direction of extension or the direction of movement of the base body. Thus, when the platform moves in a forward direction, less resistance is generated by the pin elements than when the platform moves in a backward direction.

According to another exemplary embodiment, the alignment device comprises a movable mass body which is controllable such that the base body is adjustable on the ground in the predetermined orientation.

According to another exemplary embodiment, the movable mass body is arranged at a distance from the roller element and the mass body is acceleratable along a direction unequal to the direction of extension of the base body.

Due to the acceleration of the mass body, a torque of the platform around the roller element is generated. The acceleration of the mass body may be controlled selectively, for example via a control device, so that a desired predetermined orientation of the platform may be adjusted therewith. In this embodiment, it is thus no longer necessary for the roller element to be controllable, since the directional adjustment is performed by the mass element. By selectively accelerating the mass body, the platform is moved in the opposite direction with respect to the direction of acceleration of the mass body due to the inertia. For example, mass inertial forces or Coriolis forces are generated by means of targeted movement of the mass body in order to achieve positioning of the base body.

According to another exemplary embodiment, the mass body is movable about or around the roller element, in particular along a circular or elliptical path, or along a linear path.

According to another exemplary embodiment, the alignment device comprises a guide rail which extends with a directional component perpendicular to the direction of extension of the base body. The alignment device further comprises a drive unit for moving the mass body along the guide rail. The drive unit may be an electric motor, in particular a linear motor.

According to another exemplary embodiment, the platform comprises at least one air guiding element (air control element) which is movably attachable to the base body. The air guiding element is controllable such that a flow resistance of the base body is adjustable to generate a braking effect or a steering effect. The air guiding element may be designed as a wing element or as a guide rudder and may be attached to the base body, in particular in a pivotable manner. Thus, when the base body moves, a directed flow resistance may be generated in a targeted manner, which leads to a desired steering of the base body or to a braking of the base body.

It should be noted that the embodiments described herein represent only a limited selection of possible embodiments of the invention. Thus, it is possible to combine the features of individual embodiments in a suitable manner, so that a plurality of different embodiments is to be regarded as obviously disclosed to the person skilled in the art with the embodiments made explicit herein. In particular, some embodiments of the invention are described with device claims and other embodiments of the invention are described with method claims. However, it will immediately become apparent to the person skilled in the art upon reading this application that, unless explicitly stated otherwise, in addition to a combination of features belonging to one type of subject matter of the invention, any combination of features belonging to different types of subject matter of the invention is also possible.

### BRIEF DESCRIPTION OF THE DRAWINGS

In the following, for further explanation and for a better understanding of the present invention, embodiments are described in more detail with reference to the accompanying drawings.

FIG. 1A a schematic bottom view of a platform with a hemispherical body as a ground contact element according to exemplary embodiments of the present invention

FIG. 1B a schematic side view of the platform of FIG. 1A.

FIG. 2A a schematic bottom view of a platform with elastic pin elements as a ground contact element according to exemplary embodiments of the present invention.

FIG. 2B a schematic side view of the platform of FIG. 2A.

FIG. 3 a schematic bottom view of a platform with lamellae as a ground contact element according to exemplary embodiments of the present invention.

FIG. 4 a schematic bottom view of a platform with a linearly movable mass body of the alignment device according to exemplary embodiments of the present invention.

FIG. 5 a schematic bottom view of a platform with a circularly movable mass body of the alignment device according to exemplary embodiments of the present invention.

### DETAILED DESCRIPTION OF EXEMPLARY EMBODIMENTS

The same or similar components in different figures are provided with the same reference numerals. The illustrations in the figures are schematic.

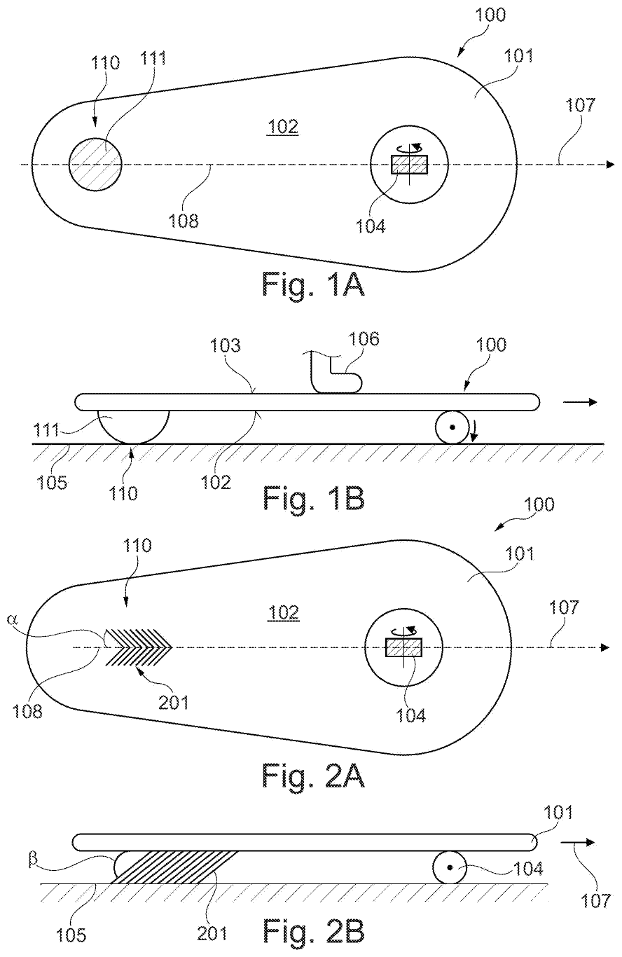

FIG. 1A shows a schematic bottom view of a platform 100 with a hemispherical body 111 as a ground contact element according to exemplary embodiments of the present invention. FIG. 1B shows a schematic side view of the platform of FIG. 1A. The platform 100 has a base body 101 which has a bottom surface 102 and a mounting surface 103 formed opposite to the bottom surface 102, wherein a dummy element 106 is attachable to the mounting surface 103. The platform 100 further comprises a roller element 104 arranged at the bottom surface 102, wherein the roller element 104 is drivable such that the base body 101 is movable along a ground 105. Further, the platform 100 comprises an alignment device 110 which aligns the base body 101 on the ground 105 in a predetermined orientation.

The dummy element 106 mounted on the platform 100 is, for example, a human-like dummy which is mounted upright on the platform 100. The platform 100 is drivable by the roller element 104 and movable along a ground 105. The platform 100, on which the dummy element 106 is arranged, may cross the travel path of the object to be tested, so that the approach of the dummy element 106 to the object to be tested may be measured by means of driver assistance systems and these may be tested at the same time.

The platform 100 comprises the base body 101, which forms a plate-like shape. The base body 101 has a bottom surface 102 and an opposite mounting surface 103. The base body 101 is placed with its bottom surface 102 on a ground 105. In the bottom surface 102, the roller element 104 is drivably arranged, which projects at least partially from the base body 101 and thus provides a distance between the base body 101 and the ground 105. The dummy element 106 is mounted on the mounting surface 103, for example by means of a mounting device.

The roller element 104 is in particular arranged in the front region in the direction of movement 107 of the platform 100, i.e. in the front half with respect to a predefined direction of movement 107 of the platform 100.

The platform 100 is movable along the ground 105 along a direction of movement 107 by means of the at least one roller element 104. In particular, the platform 100 has a direction of extension 107 which is defined parallel to a desired and predefined direction of movement 107 of the platform 100. The platform 100 is configured to be freely movable in that the roller element 104 itself is driven and, according to an exemplary embodiment, is configured to be steerable or rigid and non-steerable.

Furthermore, the platform 100 or its base body 101 has a central axis 108. In particular, the central axis 108 extends from a front end in the direction of movement 107 through a center of the base body 101 to a rear end and forms, for example, an axis of symmetry/mirror axis of the platform 100.

Further, the platform 100 comprises the alignment device 110 which aligns the base body 101 on the ground 105 in a predetermined orientation. In particular, the predetermined alignment may be the alignment in which the direction of extension 107 of the platform is adjusted parallel to a desired direction of movement 107 of the platform. In particular, the alignment device 110 is arranged at a distance from the roller element 104. In particular, the alignment device 110 is arranged behind the roller element 104 in the direction of extension or direction of movement 107 of the platform.

The alignment devices 110 in the embodiments of FIGS. 1 to 3 are configured to align the platform 100 in a predetermined orientation, for example, via a resistance to movement with the ground 105 or an active orientation system in the embodiments of FIGS. 4 and 5.

For example, the alignment device 110 in the embodiments of FIGS. 1 to 3 has a higher resistance to movement or a higher frictional force against the direction of movement 107 with the ground 105 than the roller element 104 with the ground 105. As a result, when the platform 100 moves, in particular accelerates, in the direction of movement 107, an aligning moment is generated due to the distance between the alignment device 110 and the driving roller element 104, which forces the alignment device 110 behind the roller element 104 with respect to the direction of movement 107 and thus aligns the platform 100 in the predetermined orientation.

In the embodiments, the platform comprises exactly one single roller element 104. However, other embodiments with multiple roller elements are not excluded. Due to the pairing of a single roller element 104 with the alignment device 110, which automatically stabilizes the base body 101 for example during movement along the direction of movement 107, it is not necessary to provide two or more roller elements. Only one roller element 104, which in particular is drivable, and moving the platform 100 is sufficient.

The roller element 104 is controllable relative to the base body 101 about a steering axis to adjust a direction of movement 107 of the base body 101.

In the exemplary embodiments of FIGS. 1 to 3, the alignment device 110 is formed with a ground contact element configured to contact, in particular by means of a sliding contact, the ground 105 during the movement (travel) of the base body 101 along the ground 105. The ground contact element thus forms a frictional contact with the ground 105. The ground contact element thus exhibits a higher resistance to movement or a higher frictional force with the ground than the roller element 104 with the ground 105. This results in an aligning moment being generated during movement, in particular acceleration, of the platform 100 in the direction of movement 107 due to the distance of the alignment device 110 from the driving roller element 104.

In the embodiment shown in FIGS. 1A, 1B, the ground contact element comprises a hemispherical body 111. A hemispherical shape 111 generates a small contact area with the ground 105.

FIG. 2A shows a schematic bottom view of a platform 100 with elastic pin elements 201 as ground contact elements according to exemplary embodiments of the present invention. FIG. 2B is a schematic side view of the platform of FIG. 2A. The pin elements 201 extend between the bottom surface 102 and the ground 105 along a direction of extension of the ground, wherein the direction of extension of the ground has a directional component extending along a ground plane perpendicular to the direction of extension 107 of the base body 101. The pin elements 201 extend along the direction of extension of the ground and have an angle α between the direction of extension 107 of the base body 101 and their direction of extension of the ground of less than 45°. Thereby, the pin elements extend towards the rear end in a direction opposite to the direction of movement 107 of the platform 100.

In particular, the elastic pin elements 201 exhibit a high resistance along their longitudinal direction and may be elastically deformed transversely to their longitudinal direction. For example, the elastic pin elements 201 may form a thin hair-like mat/pelt, with each of the pin elements 201 being selectively aligned. In other words, the pin elements 201 extend outwardly from the bottom surface of the platform in the direction of the ground, i.e. opposite to a central axis 108 of the platform 100. Thus, when the platform 100 moves in a rotational motion about the roller element 104 and thus from this central position, the pin elements 201 create a higher resistance.

The pin elements 201 are further arranged such that the ground extension direction has a directional component that is opposite to the direction of extension or direction of movement 107 of the base body 101 (see angle β in FIG. 2B). Thus, when the platform 100 moves in the forward direction 107, less resistance is generated by the pin elements 201 than when the platform 100 moves backward.

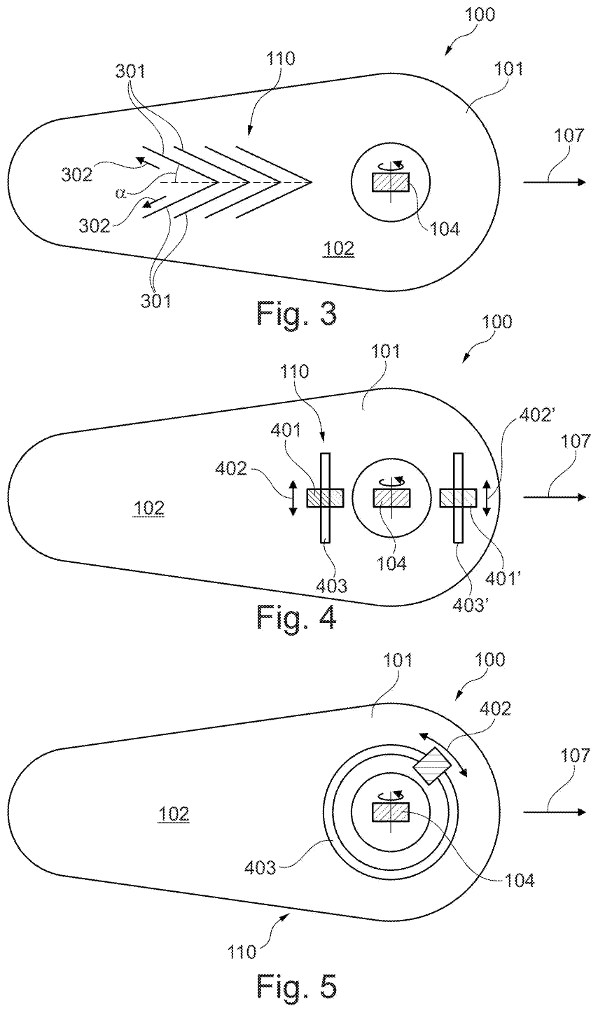

FIG. 3 shows a schematic bottom view of a platform 100 with lamellae 301 as a ground contact element according to exemplary embodiments of the present invention. The lamellae 301 have a direction of extension having a component parallel to the direction of extension 107 of the base body 101. In other words, the lamellae 301 form a friction surface with the ground 105 which has a longer extension in a direction of extension or a direction of movement 107 of the base body 101 than in a direction transverse or orthogonal to the direction of extension 107. As a result, a friction force orthogonal to the direction of movement 107 is greater than a friction force parallel to the direction of movement 107. Accordingly, when the platform 100 moves over the ground 105, on the one hand, a resistance orthogonal to the direction of movement 107 is increased compared to a resistance parallel to the direction of movement 107, and a moment is generated which brings the lamella 301 and thus the platform 100 as possible into an orientation with the lowest frictional force transverse to the direction of movement 107. This orientation typically corresponds to the predetermined orientation of the platform.

The angle α between the direction of extension of the lamella 301 and the direction of extension/direction of movement 107 of the base body is less than 45°.

Further, various ground contact elements may be provided on a corresponding platform 100, for example, as shown in FIGS. 1A to 3. Further, additional roller elements 104 may also be seen.

FIG. 4 is a schematic bottom view of a platform 100 with a linearly movable mass body 401 of the alignment device 110 according to exemplary embodiments of the present invention. The mass body 401 is controllable such that the base body 101 is adjustable on the ground in the predetermined orientation. The movable mass body 401 is arranged at a distance from the roller element 104, and the mass body 401 is acceleratable along a direction unequal to the direction of extension 107 of the base body 101. In particular, the direction of movement 400 of the second mass body does not extend through the bearing of the roller element 104, but runs past it, so that a moment is generated around the roller element 104 when the mass body 401 moves.

Due to the acceleration of the mass body 401 along its direction of movement 402 unequal to the direction of extension or direction of movement 107 of the base body 101, a torque of the platform 100 about the roller element 104 is generated. The acceleration of the mass body 401 may be selectively controlled, for example by a control device, so that a desired predetermined orientation of the platform 100 may be adjustable therewith. For example, in this embodiment, a steerable roller element 104 may be dispensed with, since the directional adjustment of the direction of movement 107 or the orientation of the platform 100 is performed by the mass element. By selectively accelerating the mass body 401, the platform 100 is moved in the opposite direction with respect to the direction of acceleration of the mass body 401 due to the inertia. The roller element 104 is, for example, rotationally fixed about a longitudinal axis, i.e. non-steerable.

The alignment device 110 has a guide rail 403 extending with a directional component perpendicular to the direction of extension 107 of the base body 101. The alignment device 110 further comprises a drive unit for moving the mass body along the guide rail 403. The drive unit represents for example an electric motor, in particular a linear motor.

In the embodiment example of FIG. 4, the mass body 401 is driven more linearly along the direction of movement 402. In particular, the mass body 401 is arranged behind the roller element 104 in the direction of movement 107. Additionally or alternatively, a further mass element 401′ may be arranged in front of the roller element 104 in the direction of movement 107. For example, the further mass element 401′ may become more linear along a further direction of movement 402′ along a guide rail 403′.

FIG. 5 shows a schematic bottom view of a platform with a circularly movable mass body 401 of the alignment device 110 according to exemplary embodiments of the present invention. The mass body 401 is movable about the roller element 104, in particular along a circular path or direction of movement 107.

In the embodiments of FIG. 4 and FIG. 5, the base body 101 may be in direct contact with the ground 105 at other areas and may drag along the ground 105 while moving. Due to the lightweight construction of the platform 100, no great wear or abrasion occurs. Furthermore, in addition to the moving mass body 401, the alignment device 110 may also comprise other ground contact elements, for example corresponding to pin elements, hemispherical bodies or lamellae.

Supplementally, it should be noted that “comprising” does not exclude other elements or steps and “a” or “an” does not exclude a plurality. It should further be noted that features or steps that have been described with reference to any of the above embodiments may also be used in combination with other features or steps of other embodiments described above. Reference signs in the claims are not to be regarded as a limitation.

### LIST OF REFERENCE SIGNS

100 Platform
101 Base body
102 Bottom surface
103 Mounting surface
104 Roller element
105 Ground
106 Dummy element
107 Direction of extension of the base body/direction of movement
108 Central axis of the platform
110 Alignment device
111 Hemispherical body
201 Pin element
301 Lamella
302 Direction of extension of the lamella
401 Mass body
402 Direction of movement of the mass body
403 Guide rail
α Angle
β Angle

1-16. (canceled)

17. A platform for testing of collisions or near-collision situations between a dummy element and an object to be tested, the platform comprising:
a base body having a bottom surface and a mounting surface formed opposite to the bottom surface,
wherein the dummy element is attachable to the mounting surface,
a roller element arranged at the bottom surface,
wherein the roller element is drivable such that the base body is movable along a ground, and
an alignment device which aligns the base body on the ground in a predetermined orientation.

18. The platform according to claim 17,
wherein the object to be tested is a vehicle.

19. The platform according to claim 17,
wherein the platform comprises exactly one single roller element.

20. The platform according to claim 18,
wherein the roller element is controllable relative to the base body about a steering axis to adjust a direction of movement of the base body.

21. The platform according to claim 17,
wherein the roller element is rotationally fixed relative to the base body about a longitudinal axis.

22. The platform according to claim 17,
wherein the roller element is configured to drive the base body along a direction of extension of the base body,
wherein the alignment device is arranged along the direction of extension behind the roller element.

23. The platform according to claim 22,
wherein the alignment device comprises a ground contact element which is adapted to contact the ground during a movement of the base body along the ground.

24. The platform according to claim 23,
wherein the ground contact element is adapted to contact the ground during a movement of the base body along the ground by means of a sliding contact.

25. The platform according to claim 23,
wherein the ground contact element comprises a hemispherical body.

26. The platform according to claim 24,
wherein the ground contact element forms at least one lamella which has a direction of extension having a component parallel to the direction of extension of the base body.

27. The platform according to claim 26,
wherein the angle between the direction of extension of the lamella and the direction of extension of the base body is less than 45°.

28. The platform according to claim 23,
wherein the ground contact member comprises a plurality of elastic pin elements extending between the bottom surface and the ground along a direction of extension of the ground,
wherein the direction of extension of the ground has a directional component extending along a ground plane perpendicular to the direction of extension of the base body.

29. The platform according to claim 23,
wherein the ground contact member comprises a plurality of elastic pin elements extending between the bottom surface and the ground along a direction of extension of the ground,
wherein the direction of extension of the ground has a directional component which is opposite to the direction of extension of the base body.

30. The platform according to claim 17,
wherein the alignment device comprises a movable mass body which is controllable such that the base body is adjustable on the ground in the predetermined orientation.

31. The platform according to claim 30,
wherein the movable mass body is arranged at a distance from the roller element and the mass body is acceleratable along a direction unequal to the direction of extension of the base body.

32. The platform according to claim 30,
wherein the mass body is movable about the roller element.

33. The platform according to claim 32,
wherein the mass body is movable about the roller element along a circular or elliptical path, or along a linear path.

34. The platform according to claim 30,
wherein the alignment device comprises a guide rail which extends with a directional component perpendicular to the direction of extension of the base body,
wherein the alignment device further comprises a drive unit for moving the mass body along the guide rail.

35. The platform according to claim 17, further comprising
an air guiding element which is movably attachable to the base body,
wherein the air guiding element is controllable such that a flow resistance of the base body is adjustable to generate a braking effect or a steering effect.
